(19) United States
(12) Patent Application Publication
(10) Pub. No.: US 2015/0244662 A1
(43) Pub. Date: Aug. 27, 2015

(54) MESSAGING APPLICATION FOR TRANSMITTING A PLURALITY OF MEDIA FRAMES BETWEEN MOBILE DEVICES

(71) Applicant: Yacha, Inc., Wilmington, DE (US)

(72) Inventors: Asantha De Alwis, Brentwood (GB); Mridul Khariwal, Pinner (GB); Ahmed Bhatti, Windsor (GB)

(73) Assignee: Yacha, Inc., Wilmington, DE (US)

(21) Appl. No.: 14/190,436

(22) Filed: Feb. 26, 2014

(51) Int. Cl. H04L 12/58; H04L 29/08

(52) U.S. Cl. CPC H04L 51/10; H04L 67/06

(57) ABSTRACT

A system and method for transmitting a plurality of media frames between mobile devices is described. The media frames comprise video data, photo data, textual data, graphical data and/or audio data.

### TECHNICAL FIELD

A system and method for transmitting a plurality of media frames between mobile devices is described. The media frames comprise video data, photo data, textual data, graphical data and/or audio data.

### BACKGROUND OF THE INVENTION

Text messaging between mobile devices is well-known in the prior art. Text messaging typically utilizes SMS or MMS technology. MMS technology also allows photos to be sent between mobile devices. However, only one photo can be sent per message. In another aspect of prior art, video clips can be shared between mobile devices using email or file sharing services such as YouTube.

One drawback of the prior art is that a mobile device cannot transmit a series of photos as one message to another mobile device. Another drawback of the prior art is that a mobile device cannot transmit a series of video clips as one message to another mobile device.

What is needed is an improved messaging system that overcomes the drawbacks of the prior art.

### SUMMARY OF THE INVENTION

The aforementioned problem and needs are addressed through an improved messaging system for mobile devices. A first mobile device can capture a series of media frames comprising photo data and/or video data and optionally comprising audio data or textual data as well. The media frames and other data are transmitted to a server, which in turn transmits them to a second mobile device. The second mobile device can view the media frames in sequence. Optionally, the second mobile device and/or server imposes a time limit on the viewing of the media frames. Any frames not yet viewed after the time limit expires will be permanently deleted.

### BRIEF DESCRIPTION OF THE DRAWINGS

FIG. 1 depicts an embodiment of a messaging system.

FIG. 2 depicts a first mobile device capturing a plurality of media files, an audio file, and a text file.

FIG. 3 depicts a media file, audio file, and text file and associated metadata.

FIG. 4 depicts a server receiving a plurality of media files, an audio file, and a text file.

FIG. 5 depicts a database storing a plurality of media files, an audio file, and a text file.

FIG. 6 depicts a second mobile device receiving a plurality of media files, an audio file, and a text file.

FIG. 7 depicts the viewing or playing of a sequence of media files along with the use of a timer.

FIG. 8 depicts the viewing or playing of a sequence of media files along with the use of a timer, where certain media files not yet viewed or played are deleted once the timer expires.

FIG. 9 depicts a user interface on a mobile device for use with the embodiments.

FIG. 10 depicts a user interface on a mobile device for use with the embodiments.

FIG. 11 depicts the storage of data regarding saved frames in a database.

FIG. 12 depicts a broadcast mode of a messaging system.

### DETAILED DESCRIPTION OF THE PREFERRED EMBODIMENTS

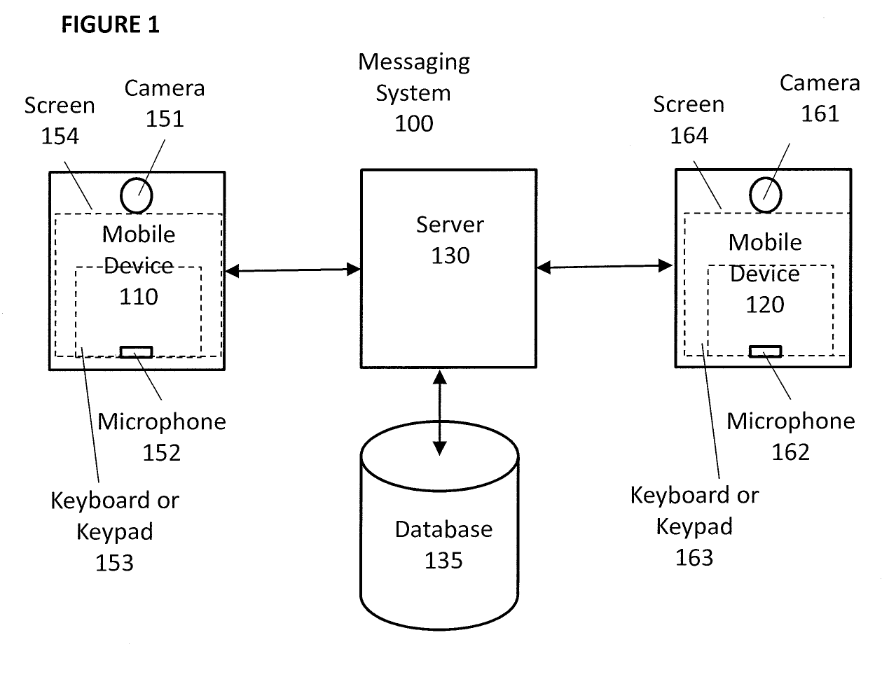

An embodiment will now be described with reference to FIG. 1. Messaging system 100 comprises mobile device 110, mobile device 120, server 130, and database 135. Mobile device 110 and mobile device 120 are portable computing devices such as mobile phones, notebooks, tablets, or other types of devices, and contain a processor, memory, non-volatile storage such as a hard disk drive or flash memory array and a network interface. Network interface enables wireless communication, such 3G, 4G, 5G, WiFi, Bluetooth, or other wireless communication. Mobile device 110 comprises camera 151, microphone 152, keyboard or keypad 153, and screen 154. Mobile device 120 comprises camera 161, microphone 162, keyboard or keypad 163, and screen 164.

Server 130 is a computing device containing a processor, memory, non-volatile storage such as a hard disk drive or flash memory array and a network interface. The network interface enables wireless communication, such 3G, 4G, 5G, WiFi, Bluetooth, or other wireless communication, or wired communication, such as over an Ethernet network.

Mobile device 110 and server 130 communicate over a wireless network, wired network, or some combination of the two. Mobile device 120 and server 130 communicate over a wireless network, wired network, or some combination of the two.

Server 130 communicates with database 135. Database 135 optionally is a relational database such as an SQL database or NoSQL database.

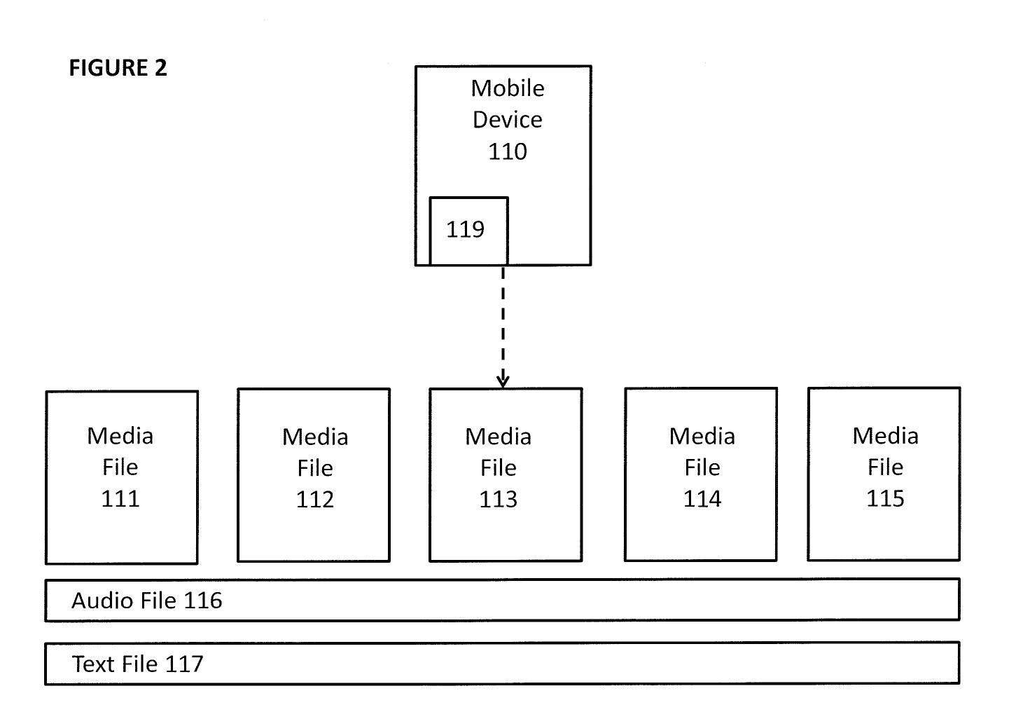

With reference to FIG. 2, mobile device 110 can generate a series of media files, shown here as media file 111, media file 112, media file 113, media file 114, and media file 115. Additional media files can be generated, but for illustration purposes, only five media files are shown in FIG. 2. Media file 111, media file 112, media file 113, media file 114, and media file 115 each can comprise photo data or video data. The photo data or video data can be captured using mobile device 110's camera 151.

Mobile device 110 also can generate audio file 116. Audio file 116 can comprise audio data. The audio data can be captured using mobile device 110′s microphone 152.

Mobile device 110 also can generate text file 117. Text file 117 can comprise textual data or other data typically generated with a keyboard or keypad 153, such as ASCII characters, graphical icons, emoticons, or emoji. Text file 117 also can contain user customizations, such as changes to the background of the message, drawings or graphical stickers added to the message,

In operation, a user of mobile device 110 can generate media file 111, media file 112, media file 113, media file 114, and media file 115 using mobile device 110's camera 151 and can generate audio file 116 by making a voice recording using mobile device 110's microphone 152. The voice recording can be conducted at the same time that the camera 151 is used or at a different time. The user also can generate text file 117 by typing a message using mobile device 110's keyboard or keypad 153 at the same that the camera is used or at a different time.

Optionally, software application 119 running on mobile device 110 facilitates the capturing and generation of media file 111, media file 112, media file 113, media file 114, media file 115, audio file 116, and text file 117. Software application 119 also can coordinate the relative timing of the files. For example, it can allow the user to specify with which media file or files the text file 117 should be displayed and to specify with which media file or files the audio file 116 should be played.

In an alternative embodiment, instead of generating audio file 116, software application 119 can generate a separate audio file for each media file. Similarly, instead of generating text file 117, software application 119 can generate a separate text file for each media file.

Optionally, software application 119 can allow the user to modify one or more of the contents of media file 111, media file 112, media file 113, media file 114, and media file 115. For example, known techniques allow a user alter a photo, for example, by drawing on it, coloring it, etc. These alterations can be saved to the media files themselves or saved in separate files that are transmitted and processed along with the media files.

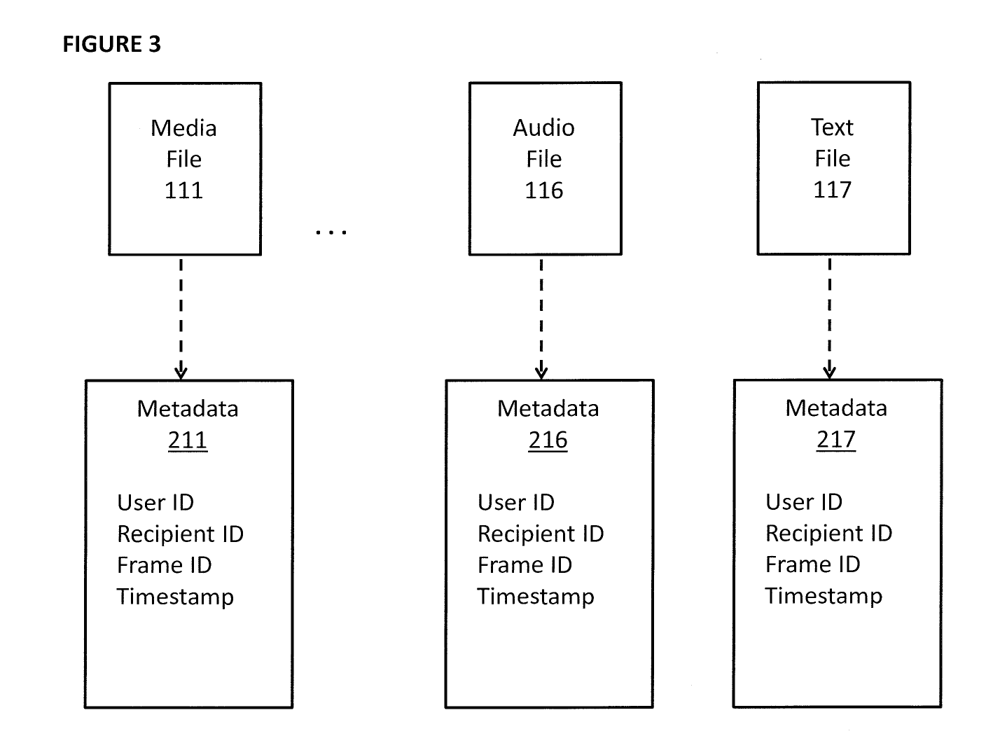

With reference to FIG. 3, mobile device 110 captures or generates metadata 211 for media file 111, metadata 216 for audio file 116, and metadata 217 for text file 217. It also captures or generates metadata for other media files, such as media file 112, media file 113, media file 114, and media file 115, in the same manner that it captures or generates metadata 211 for media file 111. For convenience, only the metadata for media file 111 is shown.

Metadata 211 comprises a User ID, Recipient ID, Frame ID, and Timestamp. Metadata 216 comprises a User ID, Recipient ID, Frame ID, and Timestamp. Metadata 217 comprises a User ID, Recipient ID, Frame ID, and Timestamp.

The Timestamp is date and time information generated by mobile device 110's clock. User ID is a unique ID associated with mobile device 110 or with the user of mobile device 110. Recipient ID is a unique ID associated with the device or user of the device to which the message will be sent. The Recipient ID optionally is gathered by software application 119 when the user of mobile device 110 sets up the message, either by obtaining the information from the user, or obtaining the information from server 130 based on other information received from the user. Frame ID is a unique ID for the frame in question, here Media File 111, and is assigned by software application 119.

After media file 111, media file 112, media file 113, media file 114, media file 115, audio file 116, text file 117, and their associated metadata have been generated, mobile device 110 transmits all of those items to server 30.

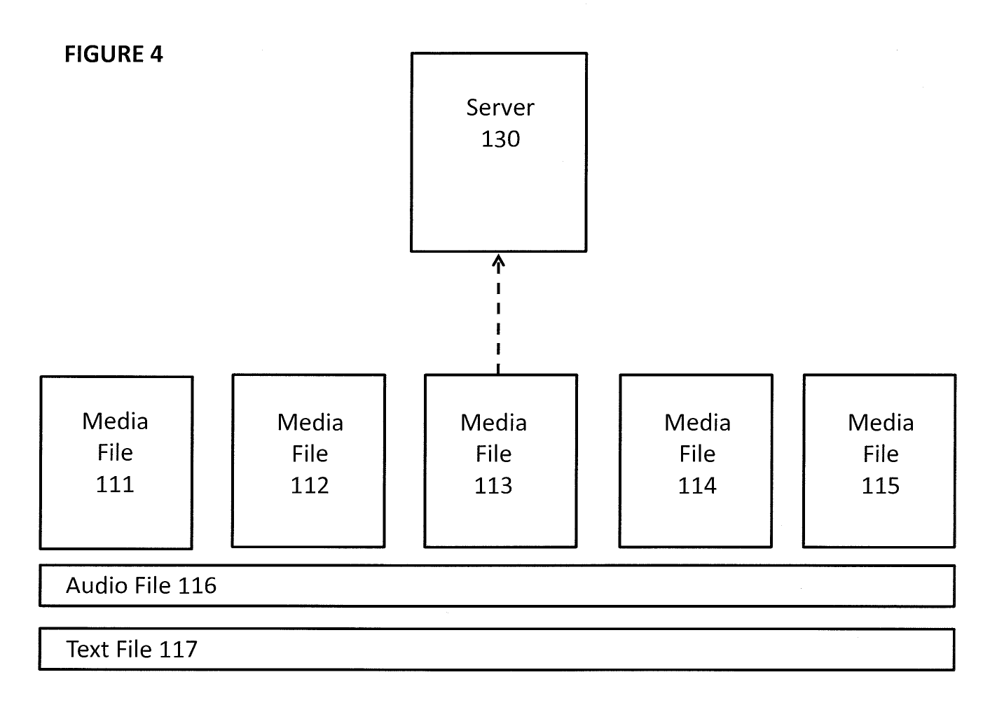

With reference to FIG. 4, server 130 receives media file 111, media file 112, media file 113, media file 114, media file 115, audio file 116, text file 117, and their associated metadata (not shown).

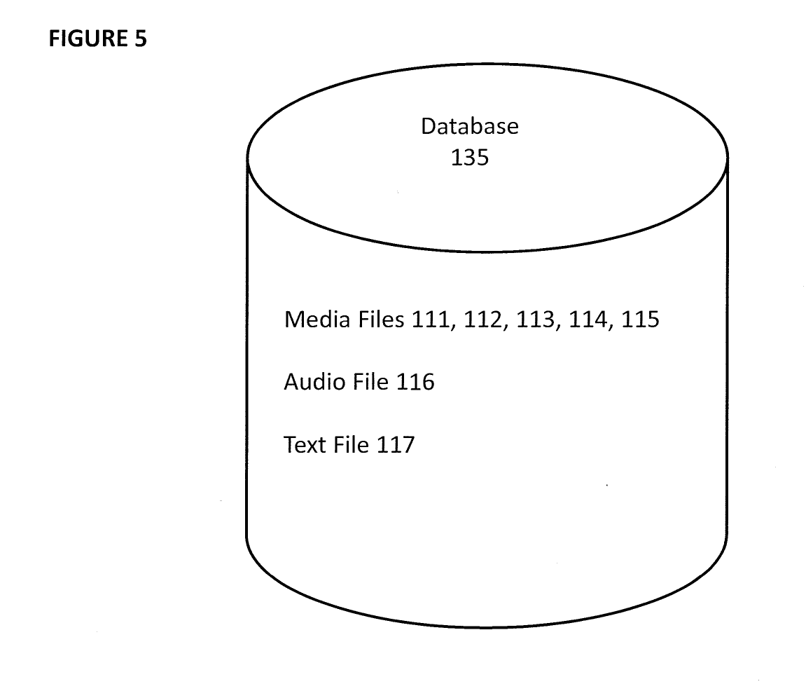

With reference to FIG. 5, server 130 stores in database 135 media file 111, media file 112, media file 113, media file 114, media file 115, audio file 116, text file 117, and their associated metadata (not shown). The keys for the table can comprise the User ID or Recipient ID.

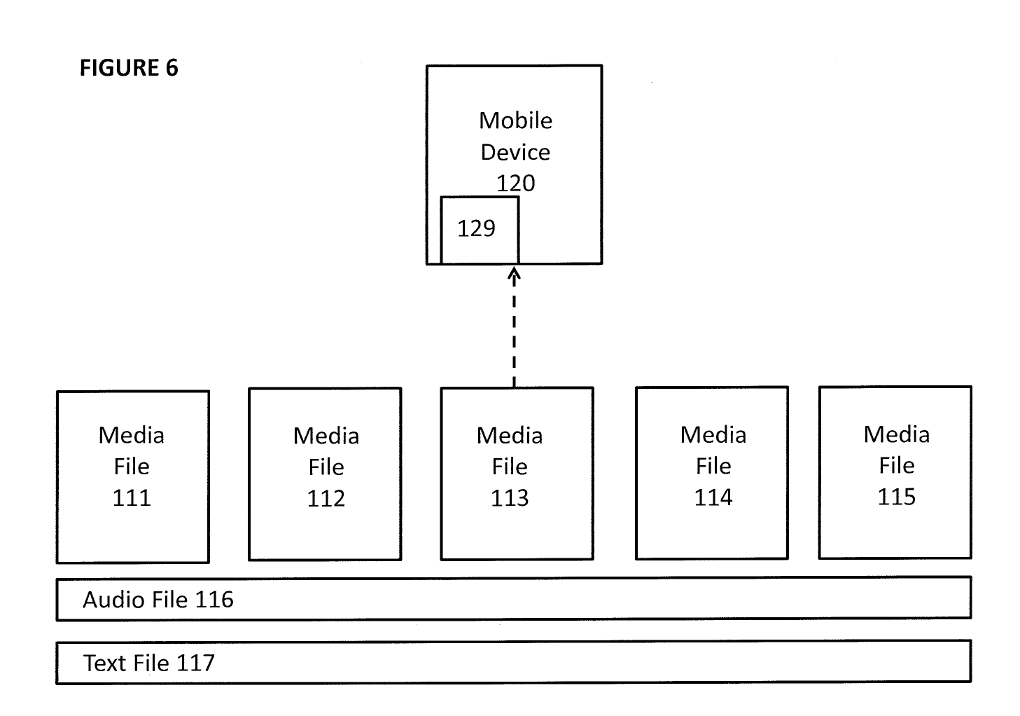

With reference to FIG. 6, mobile device 120 receives media file 111, media file 112, media file 113, media file 114, media file 115, audio file 116, text file 117, and their associated metadata (not shown).

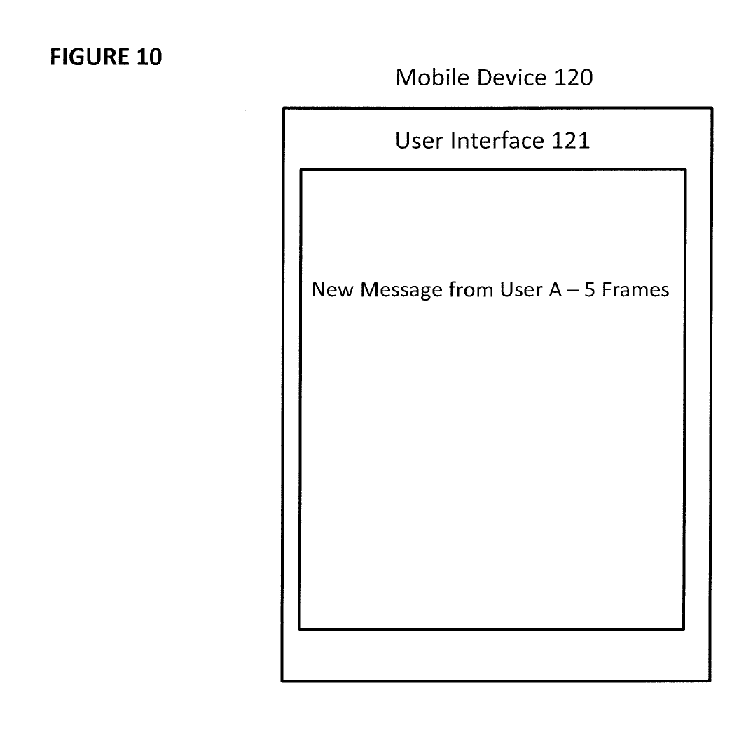

With reference to FIG. 10, software application 129 in mobile device 120 optionally generates a user interface 121. User interface 121 optionally generates an alert indicating that a message has been received from the user of mobile device 110 or from mobile device 110, and optionally indicates the number of frames in the message. Here, the alert states, “New Message from User A-Frames.”

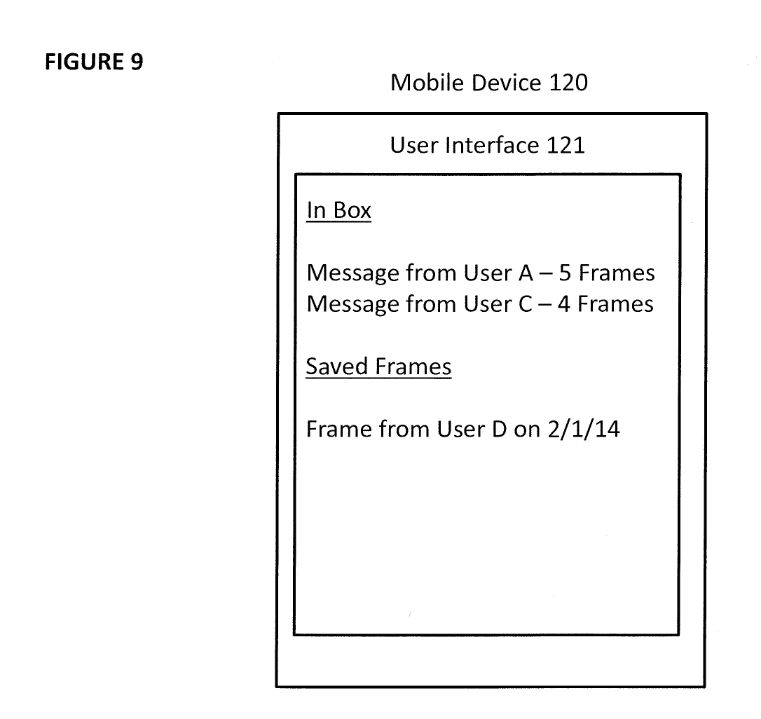

With reference to FIG. 9, software application 129 in mobile device 120 optionally generates user interface 121, which here displays the In Box for messages and indicates that a Message from User A is contained in the In Box, along with a Message from User C. User interface 121 also indicates any Saved Frames that previously were viewed.

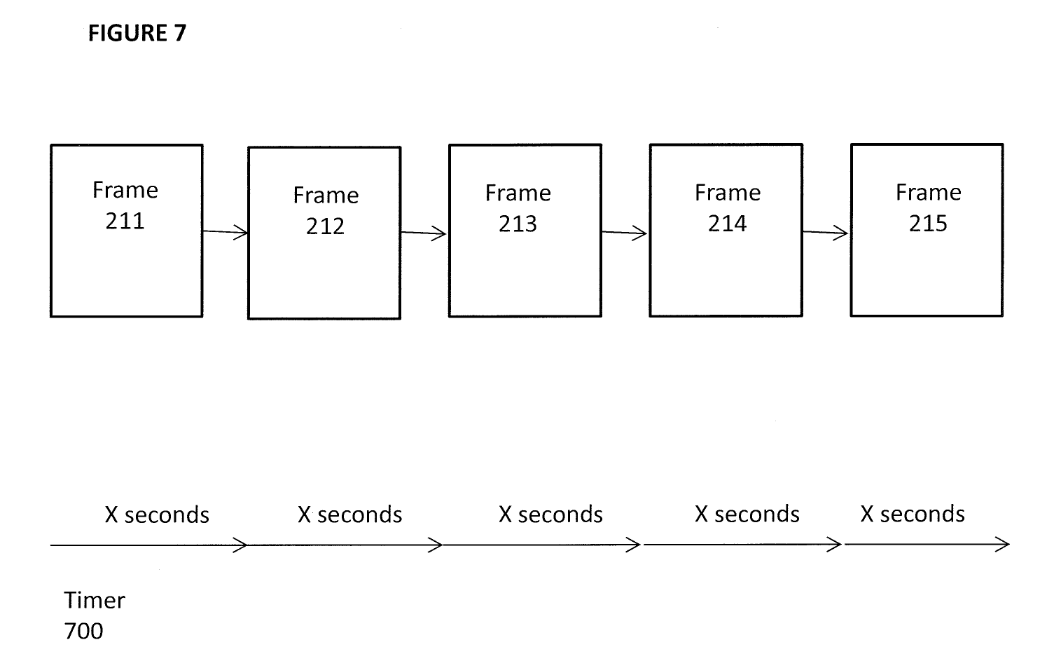

With reference to FIG. 7, once the user of mobile device 120 understands that he or she has received a message, he or she can begin viewing or playing the message. Mobile device 120 presents the message as a sequence of frames. In the example of FIG. 7, there are five frames, frame 211, frame 212, frame 213, frame 214, and frame 214. Frame 211 comprises media file 111 and any portions of audio file 116 and text file 117 that were intended to be viewed or played with media file 111. Similarly, frame 212 comprises media file 112 and any portions of audio file 116 and text file 117 that were intended to be viewed or played with media file 112, frame 213 comprises media file 113 and any portions of audio file 116 and text file 117 that were intended to be viewed or played with media file 113, frame 214 comprises media file 114 and any portions of audio file 116 and text file 117 that were intended to be viewed or played with media file 114, and frame 215 comprises media file 115 and any portions of audio file 116 and text file 117 that were intended to be viewed or played with media file 115.

In this example, frames 211, 212, 213, 214, and 215 are assembled and presented by mobile device 120 using the underlying media files 111, 112, 113, 114, and 115 and audio file 116 and text file 117 and their associated metadata. However, in the alternative, frames 211, 212, 213, 214, and 215 could instead be assembled by server 130 and sent to mobile device 120 instead of underlying media files 111, 112, 113, 114, and 115 and audio file 116 and text file 117 and their associated metadata. Or, frames 211, 212, 213, 214, and 215 could instead be assembled by mobile device 110 and sent to server 130 instead of underlying media files 111, 112, 113, 114, and 115 and audio file 116 and text file 117 and their associated metadata.

This operation begins with the user viewing or playing frame 211. Mobile device 120 or software application 129 (shown in FIG. 6) implements a timer 700 that begins when the user views or plays frame 211. The timer counts to a predetermined threshold of X seconds, which for example, could be 10 seconds. If the user instructs mobile device 120 to view or play the next frame, frame 212 before the timer 700 has reached X seconds, then frame 211 will be deleted. The user instructs mobile device 120 to view or play the next frame, for example, by swiping, tapping, pressing a link, pressing & holding the screen, making gestures, moving the phone, through optical or facial recognition, or by pressing a button within user interface 121 or in hardware, at which time mobile device 120. When a user begins viewing or playing frame 212 and any subsequent frame, timer 700 resets and begins the timing process for that particular frame, and the same procedure applies as described above for frame 211.

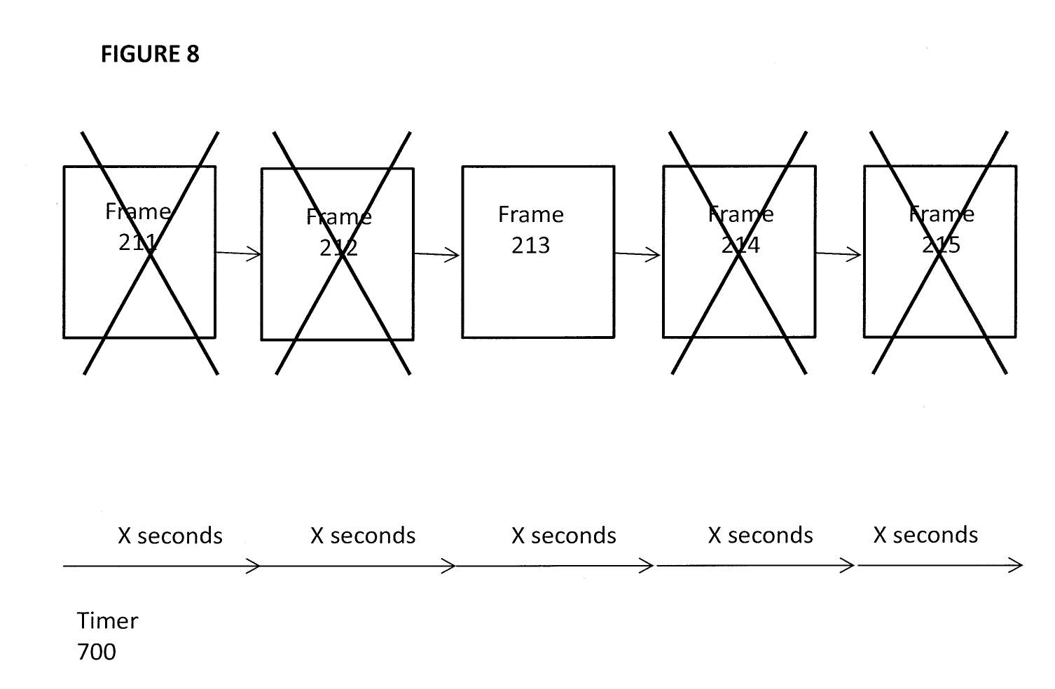

If a user continues watching or playing a frame until timer 700 expires, then that particular frame will be saved locally in mobile device 120 (in which case the frame can later be accessed in the “Saved Messages” of user interface 121 shown in FIG. 9) and/or in database 135, and all other frames will be deleted. Thus, in FIG. 8, the user viewed or played frames 211 and 212 but in each instance went to the next frame before timer 700 expired, which caused framed 211 and 212 to be deleted. The user then decided to view or play frame 213 until timer 700 expired. When that occurs, frame 214 and frame 215 are deleted, and frame 213 is saved. This happens even though the user had not yet view or played frames 214 and 215. This unique messaging system will be extremely fun for users, because when a user receives a multi-frame message, he or she will need to decide for each frame whether to save that frame (and lose all subsequent frames that have not yet been viewed or played) or to forego that frame and view or play the next frame.

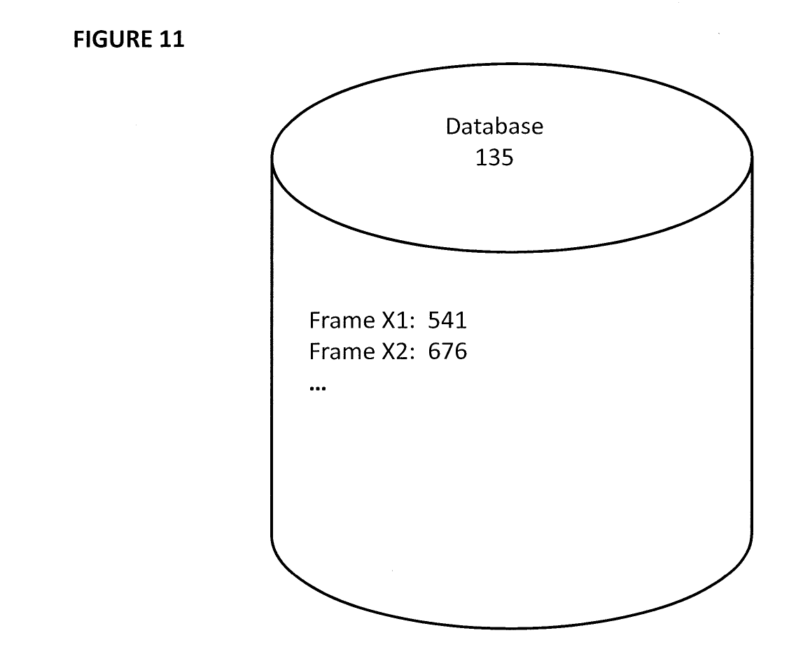

Optionally, database 135 maintains a copy of all frames that are saved by users and/or keeps aggregate data regarding the saved frames. As an example, a company could send the same multi-frame advertisement to its customers. Database 135 could keep track of the number of times each frame in the multi-frame advertisement was saved by the customers. For example, in FIG. 11, database 135 keeps a record of the number of times Frames X1, X2, etc. in a particular message is saved by the recipients of the message. This can be a useful and powerful mechanism for determining which frame in an advertisement is most effective with the target audience.

In another embodiment, a sender of messages (for example, a user of mobile device 110) would be able to view all frames that have been saved by all recipients of messages from that sender. This information can be stored, for example, in database 135 and can be transmitted to the sender's mobile device (such as mobile device 110) upon request or in real-time as the frames are saved.

In another embodiment, a frame could comprise a real-time conversation service such as video chat, audio chat, or text chat. In this instance, a message still could comprise multiple frames, one of which comprised a portal for initiating the real-time conversation service. The recipient, when viewing or playing that frame, would still be able to allow the timer to expire (and thus maintain the conversation while foregoing all other frames) or could elect to switch to the next frame before the time expires (and thus ending the conversation).

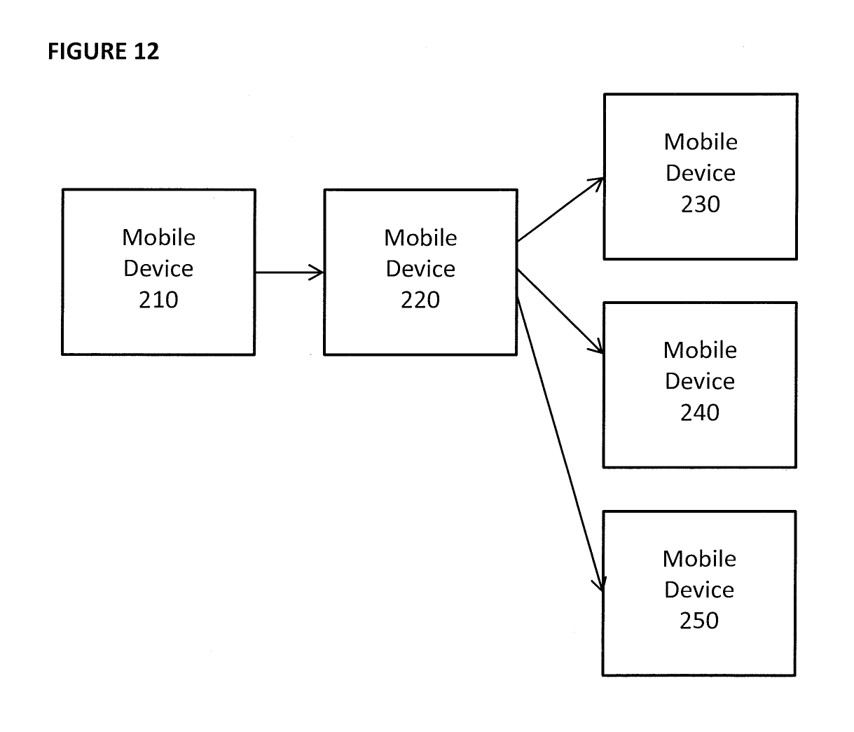

With reference to FIG. 12, a broadcast mode is depicted. Mobile device 210 sends a message mobile device 220, using the embodiments described above. The user of mobile device 220 then elects to forward the message to a plurality of his or her contacts, which causes mobile device 220 to broadcast the message to multiple users, here the users of mobile devices 230, 240, and 250. Optionally, metadata for the message will be updated with the number of users or devices who have forwarded the message. For example, when the user of mobile device 220 instructs the device to forward the message to mobile devices 230, 240, and 250, metadata for the message can be updated to contain the number one in a field indicating the number of users or devices who have forwarded the message. This number optionally can be stored and updated in database 135 as well, which has the added benefit of being able to keep a cumulative total even if multiple branches of users or devices have forwarded the message. For each branch, each time a mobile device forwarded a message, it would update database 135 with that information. Optionally, the original sender of the message (here, mobile device 210) can be updated with the information periodically or each time the message is forwarded.

The embodiments described herein provide a unique and novel messaging capability for users of mobile devices utilizing video, photos, audio, graphics and text.

References to the present invention herein are not intended to limit the scope of any claim or claim term, but instead merely make reference to one or more features that may be covered by one or more of the claims. Structures, processes and numerical examples described above are exemplary only, and should not be deemed to limit the claims. It should be noted that, as used herein, the terms “over” and “on” both inclusively include “directly on” (no intermediate materials, elements or space disposed there between) and “indirectly on” (intermediate materials, elements or space disposed there between).

What is claimed is:

1. A method of displaying a message comprising a plurality of frames on a mobile device, comprising:
displaying, on a screen of the mobile device, a first frame of the message;
initiating a timer within the mobile device for the first frame;
reaching, by the timer, a predetermined threshold;
saving the first frame on the mobile device; and
deleting all frames in the message except for the first frame.

2. The method of claim 1, wherein the message further comprises audio data and the method further comprises playing the audio data.

3. The method of claim 1, wherein the message further comprises textual data and the method further comprises displaying the textual data.

4. The method of claim 2, wherein the message further comprises textual data and the method further comprises displaying the textual data.

5. The method of claim 1, further comprising receiving the message from a server.

6. A method of displaying a message comprising a plurality of frames on a mobile device, comprising:
displaying, on a screen of the mobile device, one of the plurality of frames;
initiating a timer within the mobile device;
reaching, by the timer, a predetermined threshold;
deleting all frames of the message except for the one of the plurality of frames;
wherein each frame of the message comprises one or more of video data and photo data.

7. The method of claim 6, wherein the message further comprises audio data and the method further comprises playing the audio data.

8. The method of claim 6, wherein the message further comprises textual data and the method further comprises displaying the textual data.

9. The method of claim 7, wherein the message further comprises textual data and the method further comprises displaying the textual data.

10. The method of claim 6, further comprising receiving the message from a server.

11. A mobile device for displaying a message comprising a plurality of frames, the mobile device containing instructions to perform the following steps:
displaying, on a screen of the mobile device, a first frame of the message;
initiating a timer within the mobile device for the first frame;
reaching, by the timer, a predetermined threshold;
saving the first frame on the mobile device; and
deleting all frames in the message except for the first frame.

12. The mobile device of claim 11, wherein the message further comprises audio data and the method further comprises playing the audio data.

13. The mobile device of claim 11, wherein the message further comprises textual data and the method further comprises displaying the textual data.

14. The mobile device of claim 12, wherein the message further comprises textual data and the method further comprises displaying the textual data.

15. The mobile device of claim 11, wherein the mobile device is coupled to a server over a network to receive the message.

16. A mobile device for displaying a message comprising a plurality of frames, the mobile device containing instructions to perform the following steps:
displaying, on a screen of the mobile device, one of the plurality of frames;
initiating a timer within the mobile device;
reaching, by the timer, a predetermined threshold;
deleting all frames of the message except for the one of the plurality of frames;
wherein each frame of the message comprises one or more of video data and photo data.

17. The mobile device of claim 16, wherein the message further comprises audio data and the method further comprises playing the audio data.

18. The mobile device of claim 16, wherein the message further comprises textual data and the method further comprises displaying the textual data.

19. The mobile device of claim 17, wherein the message further comprises textual data and the method further comprises displaying the textual data.

20. The mobile device of claim 16, wherein the mobile device is coupled to a server over a network to receive the message.
